(19) United States
(12) Patent Application Publication
(10) Pub. No.: US 2017/0102086 A1
(43) Pub. Date: Apr. 13, 2017

(54) BUTTERFLY VALVE

(71) Applicant: BELIMO Holding AG, Hinwil (CH)

(72) Inventors: Werner ARNOLD, Volketswil (CH); Andreas FURRER, Wetzikon (CH); Beat WEBER, Zuerich (CH); Reto ANLIKER, Schoenholzerswilen (CH); Beat HOTZ, Uster (CH); Roy BEARTH, Embrach (CH); Paul GUYER, Duernten (CH); Piero BETTI, Valsamoggia (BO) (IT)

(73) Assignee: BELIMO HOLDING AG, Hinwil (CH)

(21) Appl. No.: 14/881,978

(22) Filed: Oct. 13, 2015

(51) Int. Cl. F16K 27/02; F16K 1/226; G05D 7/06; G05B 15/02; F16K 1/22; F16K 49/00

(52) U.S. Cl. CPC F16K 27/0218; F16K 1/221; F16K 1/222; F16K 49/002; G05D 7/0635; G05B 15/02; F16K 1/2263

(57) ABSTRACT

A butterfly valve comprises a seat ring (1), a centered valve disc (3) and a valve axis (16). The seat ring (1) and the valve disc (3) are constructed to co-operate as first and second elements of a seal for sealing a volume in which the valve axis (16) is located from internal volume of the valve. The seal is substantially a radial-force-type seal with respect to the valve axis (16). The torque for opening or closing the valve is not more than 160 Nm. The invention relates further to an actuator for a butterfly valve comprising either a voltage detection and/or a temperature and/or humidity controller and/or a safety subsystem to prevent fire in the case of fault conditions. The invention relates further to a hand crank detection system for a butterfly valve, a position indicator for a butterfly valve and an adapter between a butterfly valve and its actuator.

### TECHNICAL FIELD

The invention relates to a butterfly valve comprising a seat ring, a centered valve disc and a valve axis, wherein the seat ring and the valve disc are constructed to co-operate as first and second elements of a seal which is substantially a radial-force-type seal with respect to the valve axis. The invention further relates to an actuator for a butterfly valve comprising either a voltage detection and/or a temperature and/or humidity controller and/or a safety subsystem to prevent fire in the case of fault conditions. The invention further relates to a hand crank detection system for a butterfly valve, a position indicator for a butterfly valve and an adapter between a butterfly valve and its actuator.

### BACKGROUND ART

Butterfly valves are a very common type of fluid flow regulation devices. By controlling the amount of closing, the fluid can be caused to flow slower or it can be stopped completely. Therefore, butterfly valves are used in very different fields like e.g. housing ventilation systems or engines. Butterfly valves can regulate the flow of gases, liquids or fluidized powders. Butterfly valves can be regulated manually or with actuators. Depending on the application and the fluid passing through the butterfly valve, different sealing qualities are desired. The basic principle of a butterfly valve is to turn a disc inside a valve body having, at least locally, essentially the same cross-section as the disc. The closer the normal of the disc comes to the undisturbed flow direction, the more of the valve body opening is blocked by the disc. The flow is blocked when the valve disc normal and the undisturbed flow direction are essentially aligned. The valve disc blocks at one place inside the valve body the complete inner cross-section of the valve body. A seat ring, placed inside the valve body, forms a seal together with the edges of the disc in this case. Therefore, a seat ring improves the sealing qualities of the butterfly valve.

Seat rings for butterfly valves are described in a large number of documents. However, most of them are concerned with the sealing performance of the butterfly valve itself, i.e. the ability to divide the main volume of the valve in two parts which are separated fluid-tightly from each other.

The seal between the main volume of the valve and the valve axis containing volume is much less often described.

One example is known from AU 771 488 B2 (Okumura). Okumura uses sliding surfaces on the seat ring and on the valve disc to form a seal between the main volume of the valve and the valve axis containing volume. The valve disc comprises valve stem fitting portions. The valve stem fitting portions comprise radially outward portions. The radially outward portions slide on the sliding surface of the seat ring. The sliding surface of the seat ring is therefore curved inwardly.

While such a construction may give a reliable seal, the sliding surface and the radially outward portion have to be pressed together with the necessary sealing pressure. Therefore, there is a quite large area which causes friction resistance against a rotation of the valve disc. As a result, the torque needed to turn the valve disc is not particularly small.

Another example is known from U.S. Pat. No. 7,775,505 B2 (Asahi). Asahi's contacting surfaces are both cone shaped. The cone-shaped contacting surfaces of the seat ring and the valve disc point toward the inside of the valve (i.e. if the parts of the cone which define the surfaces are extrapolated, the tip of the resulting cone would point towards the inside of the valve). The half-opening angle of the cone of the seat ring is larger than the half-opening angle of the cone of the disc. (Whereby “cone of x” is the cone which results if the cone-shaped surface of part x is extrapolated). Asahi chooses this shape to provide a butterfly valve which prevents internal valve disc leakage in the case of a valve disc displaced by fluid pressure. Internal valve disc leakage is the leaking from the main volume into the valve axis containing volume.

Simple geometric considerations show that Asahi's geometry solves Asahi's problem to be solved only in the following way: A difference between the half-opening angles of the two cones of x degrees allows the valve disc to be displaced by x degrees. However, in order to have a seal in this displaced case, the two contacting surfaces have to be pressed together with the sealing pressure. The pressure cannot be adjusted to change with the amount of disc deformation. Therefore, already without disc deformation, there has to be at least so much pressure that the whole contacting surfaces are pressed together with the sealing pressure. Due to the geometry, in the non-deformed disc case, lines of equal pressure are circles around the valve axis. The line of maximal pressure is the one furthest away from the axis. The pressure decreases with decreasing distance to the axis. Therefore, setting the minimum pressure to the sealing pressure causes high pressure regions far away from the valve axis.

### SUMMARY OF THE INVENTION

It is the object of the invention to provide a butterfly valve system having advantages over the available standard systems. Preferably the advantages are related to costs, security or ease of handling.

According to one aspect of the invention a butterfly valve comprises a seat ring, a centered valve disc and a valve axis. The seat ring and the valve disc are constructed to co-operate as first and second elements of a seal for sealing a volume in which the valve axis is located from internal volume of the valve. The seal is substantially a radial-force-type seal with respect to the valve axis. The torque for opening or closing the valve is not more than 160 Nm. Preferably the torque for opening or closing the valve is not more than 160 Nm for a valve with a disc diameter of 300 mm.

A centered valve disc is a valve disc where the rotation axis of the valve passes through its center. The valve axis is the part of the valve which extends along the rotation axis. The valve axis consists of one or two or more parts. A single part valve axis has preferably a length greater than the diameter of the valve disc. The single part valve axis extends in the mounted state on one side through the seat ring and into a valve body and on the other side through the seat ring and through the valve body to the outside. This outwardly extending end of the valve axis can be turned either by hand or by an actuator. A two part valve axis has a first and a second part. The first part preferably extends through the seat ring and into the valve body on the one side and extends into the valve disc on the other side. A second part of the valve axis extends into the valve disc on the one side and through the seat ring and through the valve body to the outside on the other side. A valve axis comprising more parts has in addition to the two parts of a two part valve axis more parts which are preferably located inside the valve disc in the mounted state. At least a part of the valve axis and the valve disc are shaped in such a way that they cooperate with each other. A torque is exerted on the valve axis so that it rotates around its longitudinal axis. This torque is transmitted to the valve disc by the cooperation between the valve disc and the valve axis.

The actuator is preferably a motor with a reduction gear. Due to the low torque needed for closing the valve and the fact that the torque per revolution is increased by the reduction gear, the motor can have a rather small power output.

If the butterfly valve is closed, the valve disc and the seat ring form a tight seal all around the circumference of the valve disc. The valve preferably fulfills the norm EN 12266-1 (Rate A). This means that there is no visually detectable leakage for the duration of the test specified in the norm EN 12266-1, neither for liquid nor for gas.

If the butterfly valve is completely open, the fluid (e.g. gas or liquid or fluidized material) in the pipe connected to the butterfly valve can pass with little resistance. In this text, the volume through which the fluid can pass and which is connected to the pipe on both ends of the valve is called “main volume”.

There is further a seal needed which keeps the fluid out of the volume in which the valve axis is located. The volume in which the valve axis is located (“valve axis volume”) comprises the hole or recesses in the valve disc, the holes in the seat ring and the holes or recesses in the valve body in which the valve axis is placed. This valve axis volume may, at least partially, be filled with a lubricant. Using a lubricant allows to reduce the friction between the turning valve axis and fixed parts. At other places inside the valve axis volume, the valve axis volume may be filled with an adhesive or a filler. An adhesive or filler can improve the torque transfer from the valve axis to the valve disc. Independent of possible fillings, neither the filling or the air or abrasion products or anything else inside the valve axis volume should mix with the fluid transported in the pipe nor should the fluid from the main volume enter the valve axis volume. Therefore, a sealing between the valve axis volume and the main volume is needed.

A sealing requires two things:
a) a contact area surrounding the opening to be sealed and
b) a contact pressure on this contact area.

The contact pressure has to be greater than the pressure difference between the two volumes separated by the contact area. In the case of the seal between the valve axis volume and the main volume, there can be contact areas with normal vectors approximately parallel to the rotation axis of the valve axis. These contact areas can also be part of the seal dividing the main volume into two fluid-tightly separated parts when the valve is closed. If such contact areas form a seal, this is an axial-force-type seal.

In contrast to the axial-force-type seal, there is also a radial-force-type seal: In a radial-force-type seal the sealing pressure is exerted in radial direction from or to the rotation axis of the valve axis.

The torque \vec{τ} is defined as \vec{τ}=\vec{r}×\vec{F} with \vec{r} being the vector from the rotation axis to the point where the force \vec{F} is exerted. As \vec{F} is here the resistance due to friction, \vec{F} is perpendicular to \vec{r}. Therefore, τ=rF. The resistance due to friction is assumed to be proportional to the normal force. The normal force is proportional to the pressure p and the contact area A. It results that τ=μrpA with t being the proportionality constant between friction and normal force. If the pressure is not applied on a circular ring or if the pressure is not constant over the whole contact area, the torque is an integral over the whole contact area (described by parameters r and s):

τ=μ∫∫rp(r,s)drds

It follows directly from this definition of torque that having the same fixed pressure between the contact areas, the torque needed to move them against each other is proportional to the distance of the contact area from the rotation axis, r. The contact area has a defined area. In an axial-force type seal this area has to extend in radial direction while a radial-force type seal has a contact area extending in axial direction. Therefore, the torque for a given contact area size A and a given pressure p can be minimized by choosing a radial-force-type seal.

A pure radial-force-type seal is, however, difficult to produce and to install inside a valve. Therefore, the invention preferably uses a radial-force-type seal in which a significant fraction of the sealing pressure is in radial direction and another significant fraction is in axial direction. Preferably a significant fraction is not smaller than 5%, especially preferably not smaller than 10% and even more preferably not smaller than 30%, for example equal to 50%.

The direction of the pressure results from the geometry of the valve disc and the seat ring. The direction of the pressure is preferably the local normal to the contacting surfaces at the point of the contact.

By using a radial-force type seal which is preferentially located close to the valve axis, the torque needed to open and close the butterfly valve can be minimized so that torques below 160 Nm can be reached, preferably even in valves with a disc diameter of up to 300 mm. The valve preferably fulfills the norm EN 12266-1 (Rate A). This means that there is no visually detectable leakage for the duration of the test specified in the norm EN 12266-1, neither for liquid nor for gas.

In a preferred embodiment, a butterfly valve comprises a seat ring, a centered valve disc and a valve axis. The seat ring and the valve disc are constructed to co-operate as first and second elements of a seal for sealing a volume in which the valve axis is located from an internal volume of the valve. The seal is substantially a radial-force-type seal with respect to the valve axis. This butterfly valve is characterized in that the elements are constructed to limit a sealing pressure to a slim line.

The volume in which the valve axis is located is again the valve axis volume and the internal volume of the valve is the main volume. For the radial-force-type seal, the explanations given above are valid.

If the first and second elements, i.e. the contacting surfaces of the seat ring and the valve disc, are constructed such that the sealing pressure between them is limited to be exerted on a slim line, the torque needed to open and close the valve is even more reduced. This is due to the fact that the friction is approximated to be proportional to the sealing pressure p times the contact area A as shown above. Friction, μpA, multiplied with the distance from the axis, r, gives the torque, τ, needed for moving the elements relative to each other.

A sealing pressure exerted on a slim line can be realized by minimizing the area in which both elements have the same local normal to their contacting surface. This can be realized for example by a convex curvature of one of the contacting surfaces. Per definition of “curvature” the direction of the local normal of a curved surface changes from place to place. If the other element has e.g. a constant direction of its local normal, only the few places where the curved surface has the same local normal can be the places where the sealing pressure is exerted.

The area on which the sealing pressure is exerted, and this is the contact area, can be determined for example as follows: One may use coated papers like e.g. carbon paper or a paint which can be removed under pressure. This paper or paint is placed or pained onto one of the contacting surfaces. The butterfly valve is assembled and the valve disc is turned in the open and closed position of the valve and back. Then the butterfly valve is disassembled. The area on which the sealing pressure was exerted is then marked either by the absence or by the presence of paint. It may be necessary to choose the type of coated paper or the wear resistance of the paint such that the marking appears approximately at the sealing pressure.

A slim line is an area which can be described by a curve and by a locally changing extend perpendicular to the local direction of the curve. If the extent is everywhere much smaller than the length of the curve, the area is understood to be a “slim line”. Preferably the extent is nowhere greater than 5% of the length of the curve, more preferably the extent is nowhere greater than 1% of the length of the curve.

In another embodiment, a butterfly valve is characterized in that a first contacting surface associated with the first element is convex-shaped and rounded in a radial cross-section with respect to the valve axis and a second contacting surface associated with the second element is cone-shaped in a radial cross-section with respect to the valve axis.

This is one way how the sealing pressure can be exerted on a slim line and how a radial-force-type seal can be realized.

The convex-shaped and rounded cross-section of the first contacting surface produces on this contacting surface everywhere different local normals. The areas in which the two contacting surfaces have the same local normal are circles around the rotation axis. Note that two normal are “the same” in the context of this text, if they point in the same or in opposite directions. I.e. their algebraic signs are ignored for the purpose of comparison.

The cone shape of the other element produces a pressure component in radial direction, even if the two elements are pressed together in axial direction. Therefore, a radial-force-type seal is constructed.

In another embodiment, a butterfly valve is characterized in that the contacting surfaces of both elements are rounded in a radial cross-section with respect to the valve axis.

This is another way how the sealing pressure can be exerted on a slim line and how a radial-force-type seal can be realized.

In this embodiment either both contacting surfaces can be convex or one can be convex and one can be concave.

In the first case, one possible realization is similar to placing a sphere on a doughnut. The pressure will be exerted on the contact line of these two shapes. Another possible realization is a situation similar to placing two doughnuts of possibly different sizes onto each other. The pressure will be exerted on the contact line of these two shapes. Neither the valve disc nor the seat ring is doughnut-like or spherically shaped. The examples given here relate only to the shapes of the contacting surfaces. And also the contacting surfaces are preferably not completely spherical or doughnut-shaped. Only parts of the contacting surfaces can preferably be described by parts of a spherical or doughnut-shaped surface. The sphere and doughnut shapes can also be flattened in another embodiment. Note that the sizes and defining parameters of the different elements can vary. By varying the sizes and defining parameters, the fraction of radial and axial sealing pressure can be set as well as the distance from the rotation axis in which the sealing pressure is exerted.

In the second case, one possible realization is similar to placing a sphere in a rotational ellipsoid or to place a doughnut into a sphere or to place a doughnut into a rotational ellipsoid. The pressure will be exerted on the contact line of the two involved shapes. Neither the valve disc nor the seat ring is doughnut-like, spherically or rotational ellipsoid-like shaped. The examples given here relate only to the shapes of the contacting surfaces. And also the contacting surfaces are preferably not completely spherical or doughnut-shaped or a rotational ellipsoid. Only parts of the contacting surfaces can preferably be described by parts of a spherical or doughnut-shaped surface or a rotational ellipsoid. The sphere and/or doughnut shapes can also be flattened in another embodiment. Note that the sizes and defining parameters of the different elements can vary and by varying these sizes and parameters the fraction between radial and axial sealing pressure can be chosen as well as the distance from the rotation axis in which the sealing pressure is exerted.

A “defining parameter” is a parameter defining the shape of an element. For a rotational ellipsoid these are for example the parameters defining the curve and the axis around which the curve is rotated in order to produce the rotational ellipsoid. In the case of a doughnut, defining parameters are for example the radius of the ring and the rotation axis as well as parameters describing the shape which extends along the ring. In the simple case of a doughnut with a circular shape on the ring, the defining parameters are the radius of the ring, the radius of the circular shape and the axis. The axis passes through the center of the ring and is perpendicular to the plane of the ring.

In another embodiment, the first and/or the second contacting surface is rounded in a radial cross-section with respect to the valve axis and encircles the valve axis completely at a predetermined axial position with respect to the valve axis.

The examples given above are all rotationally symmetric around the rotation axis of the valve and, therefore, they are also examples of this embodiment. This is because the rotation axis of the valve is located inside the valve axis in a centered disc butterfly valve. However, one may also realize a seal which shows all features of this embodiment but is not rotationally symmetric. For example, one of the contacting surfaces can change between flat cone part and circle segment parts if one follows the contracting surface once around the rotation axis. The other contacting surface can be everywhere a circle segment part if one follows the contacting surface once around the rotation axis. A “flat cone” respectively a “circle segment part” is a part of a contacting surface where a cross-section including the rotation axis of the valve has the shape of a flat cone segment respectively the shape of a circle segment.

In another embodiment a cone-shaped contacting surface is formed such that the contacting surface comes closer to the co-operating element with increasing radial distance with respect to the valve axis.

Such a cone-shaped contacting surface pushed the other contacting surface towards the valve axis. As the valve axis is a fixed boundary, this results in increasing the sealing pressure with increasing axial pressure between valve disc and seat ring if the co-operating element is deformable. Note that a pressure exerted by one of the sealing elements onto the valve axis is not desired because it increases the torque but it is still preferred to a leakage of the seal.

In another embodiment the cone-shaped contacting surface is associated with the valve disc and the convex-shaped and rounded contacting surface is associated with the seat ring.

It is preferable that every part consists of a single material. Such parts are easier to manufacture and more reliable. The valve disc is typically essentially non-deformable as it needs to withstand the pressure of the liquid when the valve is closed. The seat ring is typically made of an elastic material in order to provide good sealing qualities when the valve is closed. Therefore, if the contacting surface of the valve disc is cone-shaped, the cone-shaped region is essentially non-deformable. It contacts the deformable, rounded contacting surface of the seat ring. This is one example where the sealing pressure increases with increasing axial pressure between valve disc and seat ring if the cone-shaped contacting surface comes closer to the co-operating element with increasing radial distance with respect to the disc axis.

In another embodiment the rounded contacting surface of at least one element is part of a protrusion of said element towards the co-operating element, preferably the protrusion is a protrusion of the seat ring which protrudes towards the valve disc.

A rounded protrusion can be described as O-ring-like feature as it behaves similar to an O-ring placed at its location.

In another embodiment the protrusion including the rounded surface is the region closest to the valve disk.

In this embodiment, the contacting surface of the seat ring is a rounded surface. If this rounded surface is the region closest to the valve disk, preferably closest to the central point of the valve disk, this means that the seal between the main volume and the valve axis volume is located in a small region and does not influence the shape of the valve disc or the seat ring outside of this region. This allows using the suggested seal in many different seat rings and valve disk designs.

In another embodiment the distance between the seat ring and the valve disc does not decrease along a line. The line starts at the point with the smallest distance between seat ring and valve disc on the protrusion. The line extends away from the rotation axis of the valve axis in radial direction in at least one radial cross-section with respect to the valve axis.

This is an intensification of the embodiment in which the rounded surface is the region closest to the valve disc. In this embodiment, there is a radial cross-section in which the distance between the seat ring and the valve disc increases with increasing distance from the point of the rounded protrusion. The distance from the protrusion is measured positively on a radial pointing away from the rotation axis. A radial cross-section is a cross-section which includes the rotation axis and one of its radials. Note that in this picture it is always assumed that the cross-section includes the central cross-section of the valve disc. This means that the valve disc is assumed to be in the open-position if the cross-section contains the valve axis as well as the direction of the fluid flow in the open-position of the valve. The valve disc is assumed to be in the closed-position if the cross-section contains the valve axis as well as a plane normal to the fluid flow direction in the open-position of the valve. The same applies for all angles in between the direction of the fluid flow and the direction perpendicular to it. In other words, for the evaluation of this embodiment, the cross-section shows the maximum extent of the valve disc.

This embodiment has the advantage that the seal between main volume and valve axis volume is independent of the seal between the two parts of the main volume in the closed-position of the valve.

In another embodiment there is a second protrusion protruding in radial direction towards the valve axis, whereby the second protrusion stabilizes the position of the protrusion. The second protrusion seals a first volume between the valve disc and the valve axis from a second volume between a valve body and the valve axis.

It was stated above that a pressure between one of the sealing elements and the valve axis is not desirable as it increases the torque. Although there is an increase in torque, there are good reasons for separating the valve axis volume in at least a first and a second volume The first volume, comprising the space between the valve disc and the valve axis, contains no parts which move relative to each other except for seals. Therefore, neither a lubricant nor abrasion products are desired or expected in this region. The second protrusion prevents lubricants and abrasion products from entering the first volume. Also, the first volume is located inside the valve body and therefore a leakage into this volume may be accepted or may be more acceptable than a leakage towards the outside of the valve body. For example, an actuator of the valve may be destroyed by an aggressive liquid transported through the valve and leaking into the actuator. But a small amount of liquid leaking from one part of the main volume into the other part in the closed-position may be negligible compared to the amount of fluid sticking on the pipe surfaces after closing the valve, anyway.

The second volume comprises the part of the valve axis volume in which parts move relative to each other. I.e. the valve axis rotates inside the stationary valve body. The second volume is connected to the outside where e.g. an actuator or a hand crank for manual operation of the valve is connected to the valve axis.

The disadvantage of a contact with pressure having an increase in torque is mitigated by the use of a second protrusion. A second protrusion minimizes the area in which the sealing pressure is exerted, compared to the case of a contact due to a deformation of the protrusion. Further, the sealing pressure p is exerted close to the rotation axis such that the increase in torque τ is small. This is because of the relationship τ=μrpA, which shows that the torque, τ, can be decreased by decreasing the contact area, A, and the distance from the axis, r, at a given sealing pressure, p.

The stabilizing effect of the second protrusion on the protrusion relaxes the requirements on the material of the seat ring and/or on the design of the protrusion. The stabilizing effect allows for example to move the contacting surface closer to the valve axis: The protrusion does not need to be as thick in radial direction as it would need to be without second protrusion. Without a second protrusion the protrusion has to be designed, geometrically and material-wise, so that it can exert the sealing pressure onto the valve disc. As the seal is a radial-force-type seal, a significant fraction of the sealing pressure acts in radial direction. While the valve body supports the seat ring and therefore the protrusion in axial direction, there is no support in radial direction without second protrusion.

In another embodiment there is a third protrusion which protrudes in radial direction towards the valve axis. The third protrusion is further away from the disc than the second protrusion. The third protrusion seals a third volume between the valve body and the valve axis from a fourth volume between the valve axis and an outside and/or a valve actuator.

The second volume is in this embodiment divided into a third and a fourth volume. The division in a third and a fourth volume has for example the following advantages:
a) One can use a lubricant between valve axis and valve body in the third volume. The third protrusion is a seal between the third and the fourth volume. The actuator or on the hand crank which can be connected to the valve axis are outside the valve body and therefore inside the fourth volume. Due to the third protrusion the lubricant cannot reach the hand crank or the actuator.
b) The third protrusion is part of a third seal between the main volume and the outside. Thereby, the risk for a leakage to the outside of the valve is decreased and the actuator is protected, if one is present.

In another embodiment, the third protrusion is at least partially shaped like an O-ring.

The O-ring-like shape enables a small contact area and sufficient sealing pressure. It is a well known and trusted technology.

In order to provide the function of an O-ring, only the contact area has to have the shape of an O-ring. As the seat ring is made of a suitable material the third protrusion has the shape of the inner half of an O-ring, in a preferred embodiment. In order to illustrate the shape, imagine that an O-ring is described by a large radius L and a small radius S. A large circle with the radius L defines the center points of circles having the small radius S. The volume of the O-ring is defined by the integral of all circles with radius S. Now, define an infinitely long circular cylinder which includes the large circle with radius L. The direction of the longitudinal axis of this cylinder is equal to the normal of the plane defined by the large circle with radius L. Everything of the O-ring inside this cylinder is what is called “the inner half of an O-ring” above.

Other partially O-ring-like shaped protrusions can be constructed by choosing the radius of the cylinder to be somewhere in the interval of [L−S; L+S] and to pick all points of the O-ring inside this cylinder.

In another embodiment the seat ring is composed of elastomer and the valve disk is composed of a less flexible material than the seat ring, preferably of steel.

The valve disc has to withstand the pressure of the liquid if the valve is closed. Therefore, it should not deform significantly. At the same time, a tight contact has to be established between the sealing elements. In the case of a closed butterfly valve the sealing elements are the seat ring and the valve disc. A tight contact which can be released and established many times is very difficult to realize between two non-elastic materials. Therefore, the seat ring is preferably composed of an elastic material which can adapt its shape adequately. The material of the seat ring allows establishing a tight contact with the valve disc when the butterfly valve is closed. The material of the seat ring returns to its original shape once the pressure on it is released.

An adapter for the connection of a butterfly valve axis to an actuator comprises an actuator receiving element and an axis receiving element. The actuator receiving element is fixed to or is a part of an actuator. The axis receiving element is fixed to or is a part of a valve body. The actuator receiving element and the axis receiving element can be detachably connected to each other. Preferably, the actuator receiving element and the axis receiving element have form-fitting shapes and/or screws to fix the position relative to each other.

The axis receiving element comprises a bottom and a top part. The bottom part surrounds the valve axis and the top part comprises four sections, each of approximately 90°. Two sections, being on opposite sides of the valve axis, comprise axis-receiving-element-protrusions and the other two sections do not comprise an axis receiving part and are void of any obstacles.

The actuator receiving element preferably comprises two base sections which can receive the axis-receiving-element-protrusions of the axis receiving part at least partially. Preferably each of the two base sections is only partially surrounded by parts, preferably parts of the actuator receiving element, which are elevated compared to the base section. It may be that other parts surrounding the base section are ever lowered compared to the base section. Preferably the actuator receiving element is a structure of the housing of the actuator. Alternatively, the actuator receiving element is fixed to the actuator housing by fixing means like e.g. screws, adhesives, binder, bands, clip systems and similar techniques. Preferably the actuator receiving element comprises also threads for receiving screws at defined positions to allow a connection to a standard ISO flange. Such means are typically. Preferably these threads for receiving screws are on protrusions such that the standard flange and the actuator receiving element are in direct contact at the place where the screws connect the valve flange to the actuator receiving element.

Such an adapter allows coupling and decoupling valve and actuator to resp. from each other in a fast and reliable way. An adapter can also help to reduce vibrations and heat transfer from the actuator to the valve or vice versa. An adapter can also be used to place the actuator at a better accessible place.

Preferably, for fixing the actuator receiving element to the axis receiving element only two screws are needed while still allowing the same torque transfer as in a standard ISO flange connection. This is possible because the screws are located further away from the rotation axis than the screws used in the standard ISO connection. This location has also the advantage that the screws are easier to reach and therefore the installation process is easier and faster due to location and a smaller number of screws. Preferably, the screws are connected to the axis receiving element in such a way that they cannot get lost. The form fit elements of the actuator receiving element and the axis receiving element facilitate the placement of the two parts relative to each other.

A section of 90° of a part can be defined as follows: One uses cylindrical coordinates, height, radius and angle. The rotation axis of the valve axis is the height axis. The height increases from the inside of the valve towards the outside. The radius is measured perpendicular to the rotation axis and increases with increasing distance from the rotation axis. The angle is measured in a plane perpendicular to the rotation axis, increasing in a given direction starting from some given reference direction. A section of 90° is a volume which covers all angles in an interval of 90°. Preferably a section of 90° covers also all heights in a height interval and/or all radii in a radius interval. Such a section of 90° is ¼ of a cylinder with a wall thickness equal to the radius interval and a height equal to the height interval.

Sections of the top part are sections with the smallest height coordinate being equal to the height coordinate of the upper surface of the bottom part and a largest radius coordinate being smaller than twice the largest radius coordinate of the bottom part.

If the actuator receiving element comprises two base sections for receiving the two axis-receiving-element-protrusions, the positioning of the axis receiving element relative to the actuator receiving element is simplified. This is also true if the base sections can receive only parts of the axis-receiving-element-protrusions. A form-fitting connection between the axis-receiving-element-protrusions and the base sections can be stable enough to avoid holding devices or an additional person holding e.g. the actuator during the mounting procedure. The mounting procedure can include e.g. the tightening of screws. Further, the form-fitting connection allows a more simple alignment of the actuator receiving element relative to the axis receiving element. However, a mounting is also possible without the two base sections of the actuator receiving element. Depending on the weight and the size of the actuator, holding and fixing the actuator at the same time can be a simple procedure. The absence of base sections can allow mounting the actuator in different positions.

In one embodiment, the valve and the actuator are built to be used together and to form a single fluid flow regulating device. This has the advantage, that the valve and the actuator can be optimized for their use: The power of the actuator can be just enough to close the valve securely. Thereby, energy and costs are saved compared to a combination of two independent parts.

It is also possible to use a particular control method: Preferably the actuator generates a maximum torque and this maximum torque is set in such a way that the valve is tightly closed but not more than needed for this tight closure. This torque defines preferably a predefined fixed maximum value of torque. Only if there is no position in which this maximum torque can be applied, the actuator moves the disc to a predefined position. Controlling the maximum torque has several advantages: On the one hand, such a control is actuator friendly as there is no situation in which the control demands more than the actuator can provide. More important, however, this control compensates for deformations of the seat ring e.g. due to thermal expansion or wear: The sealing qualities depend on the pressure between the sealing surfaces and, therefore, in this case directly on the torque with which the disc is pressed against the seat. Therefore, a constant torque control allows keeping a constant sealing quality.

Preferably, an actuator and a valve which are constructed to belong to the same fluid flow regulating device comprise interfaces which are designed for optimal torque transfer, especially a spline connection. It is well known that a spline connection transfers torque better than the usual square profile. However, as the square profile is the ISO norm, valves and actuators which are constructed and sold as independent parts have this connection.

Another possibility to use spline connections on standard actuators and valves is the use of adapters which receive on the one side the square connection element and provide on the other side a spline connection element. It is, however, clear that due to losses in these adapters, they do not reach the efficiency of spline connection elements directly connected to the valve or the actuator. Adapters between spline and square connections can be used if only one of the connection parts is initially a spline connection and the other one is a square connection. Thereby, a standard valve can be combined with an actuator which was indented to be part of fluid flow regulating device.

An actuator for a butterfly valve, in particular an actuator of a fluid flow regulating device, preferably comprises voltage detection means. The voltage detection means are coupled to a variable input resistance. The input resistance is chosen such that the voltage available to the circuit behind the resistance has a given value independent of the input voltage. Preferably, this input voltage correction is suitable for input voltages between 19 V and 265 V AC or DC.

The advantage of such an actuator is that a single actuator can be used on all common power nets and usual power supplies. The actuator includes preferably control means and the electronics well-known for similar actuators.

If the input voltage is a control signal, the control means and a common control-signal receiving unit are preferably separated by a galvanically isolated digital output.

The control means include a voltage detection unit. The voltage detection unit determines the input voltage. Preferably, the voltage detection unit determines the effective voltage as well as the waveform of the voltage. Depending on the results, a variable input resistance is chosen such that a pre-determined voltage results on the output of the control means. Preferably, there is also a current control device which measures and controls the current such that a pre-determined current results on the output of the control means. Preferably, there are also waveform changing elements with which the waveform of the voltage resp. the current is changed to a desired shape if necessary. Examples of waveform changing elements are capacities, inductances, diodes and various types of switches among others. The well-known actuator electronics receives, therefore, power with the pre-defined voltage and the pre-defined current having the desired waveform.

In another embodiment an actuator for a butterfly valve, preferably an actuator of a fluid flow regulating device, comprises a temperature and/or humidity controller. Such a temperature and humidity controller comprises one or more sensors for temperature and/or humidity and one or more heaters. The heaters are controlled depending on the sensor measurements in order to avoid condensation of humidity in or on the actuator and/or in order to prevent frost in or on the actuator or movable parts close to it.

Condensation of water vapor can be a problem as liquid water can cause erosion in the actuator and short circuits in electronic systems. Frost or low temperatures can be a problem as movable parts may be blocked or lubricants can become too viscous.

The dew point or condensation point of water vapor depends strongly on the temperature. Humidity is measured relative to the water vapor partial pressure at the dew point at the current temperature. A temperature change changes this reference value of the partial pressure. Therefore, heaters can lower the humidity and thereby the occurrence of condensate.

Sensors for humidity as well as for temperature are preferably placed at positions where the worst conditions are expected. For example at a place far away from all heat producing elements and not exposed to the sun or similar environmental heaters. Another possibility is to place sensors at all critical places or to place a single sensor at any place. More sensors need a more sophisticated controller. A single sensor at a random place needs to start the heaters earlier than probably necessary in order to ensure sufficient heating even in the case of an adverse sensor placement.

Heaters are preferably placed at critical positions. A critical position can be close to moving parts where frost is feared or close to electrical systems where condensates may cause a short circuit for example. If there is only a single sensor, preferably all heaters are switched on at once. If there are more sensors, the heaters are preferably switched on as needed at the different places. The heaters can have a single heating power or their heating power can be regulated. The second option needs a more sophisticated controller. All heaters can be of the same type or they can differ depending on their placement.

In another embodiment, the actuator for a butterfly valve, preferably an actuator of a fluid flow regulating device, comprises a safety subsystem which protects the actuator from risk of fire in fault conditions. The safety subsystem comprises electronic hardware and software running on and controlling the electronic hardware. The software comprises three parts: a bootstrapper, a boot-loader allowing software updates in boot mode and the actual safety firmware.

The safety subsystem allows the use of not UL-certified actuators, i.e. actuators which are not certified by the “Underwriters Laboratories”.

There are two modes of operation for the safety controller: First, a run mode in which the safety software is executed when the actuator is switched on. Secondly, a boot mode in which the bootstrapper and/or the boot-loader runs when the actuator is switched off.

The safety software parameter set can be loaded independently of the safety software.

There is a possibility for communication in the boot mode which allows reading the status parameters. This makes it possible to analyze the behavior of the safety controller.

In a preferred embodiment, the actuator comprises a hand crank detector for a butterfly valve, characterized in that there is an IR light barrier inside a socket for a hand crank which gives out a signal which prevents the operation of an actuator for a butterfly valve if the IR barrier is disturbed.

A hand crank detector prevents the use of a hand crank with running actuator. The hand crank detector is basically an infrared (IR) light barrier inside a channel in which the hand crank is inserted. An IR light barrier comprises an IR source and an IR receiver. The IR source emits constantly IR radiation which is detected by the IR receiver if there are no obstacles in between them. The hand crank shaft is an obstacle and prevents the detection of the IR radiation emitted by the IR source. This loss of signal causes the actuator to switch off. Preferably, a hand crank detector electronic detects the loss of signal and sends a control signal to the actuator electronics. Alternatively, the hand crank detector electronics disconnects the actuator from its power source when a loss of signal is detected.

The hand crank detector is preferably placed inside the actuator housing. It is therefore invisible to the user and can use for example the power supply of the actuator.

In a preferred embodiment, there is an indicator for the position of a butterfly valve disc. The indicator comprises a flexible stick. This stick can be coupled to a valve axis of the butterfly valve. The stick is oriented in the same direction as the valve disk. The stick and the valve disc have always the same orientation.

Preferably, there is at least one well visible end piece mounted to the end of the stick. Preferably, the stick itself has a well visible color and/or shape. Preferably, the stick itself and/or its end pieces are reflective in visible wavelengths. Preferably, the stick is symmetric with respect to the valve axis in the mounted state.

The coupling between the stick and the valve axis is done in such a way that the stick rotates together with the valve axis. A simple and preferred way of realizing such a coupling is to place a ring with an inner cross-section which is not everywhere circular on a complementary shaped valve axis or a complementary shaped coupling device connected to the valve axis. Due to the non-circularity, the valve axis and ring cannot rotate with respect to each other. In this way, the ring has to rotate with the valve axis. Such a ring can be connected to one or two or more sticks, preferably to two sticks. The two sticks can point in opposite directions. This results in one embodiment of a position indicator.

The flexibility of the stick prevents damages and injuries. The length of the stick and the size of possible end pieces can be chosen so that the position indicator is visible and readable from a convenient position.

In another embodiment, there is additionally a similar stick called reference indicator. The reference indicator has preferably a different color and preferably different end pieces. The reference indicator stays in a fixed position, independent of the rotation of the valve disc. The reference indicator can be installed below or above the position indicator. For example it can be fixed to the axis receiving element of an adapter. The reference indicator can indicate for example the open or closed position of the valve disc. This reference indicator allows determining the position of the valve even if the orientation of the pipe to which the valve is connected, is not visible from a convenient observation position.

Preferably, the position indicator is mounted on the valve axis or on a coupling device connecting the valve axis with the actuator at a height of the actuator receiving element of the adapter. The empty sections allow the one or two or more sticks of the position indicator to extend beyond the adapter so that they are well visible. As the valve disc turns around 90° between the fully closed and fully opened position and as the void, obstacle-free sections are about 90° wide, the actuator receiving element does not influence the position indicator.

A flow regulating device comprises a butterfly valve and an actuator. Preferably, it comprises a butterfly valve according to any one of the embodiments described above. Preferably, when closing the valve, the actuator rotates the valve disc inside a defined interval of rotation angles until either a predefined fixed maximum value of torque is reached or the end point of the defined interval of rotation angles is reached. Preferably an actuator control unit is designed to control the actuator while closing the valve, whereby the actuator rotates the valve disc inside a defined interval of rotation angles until either a predefined fixed maximum value of torque is reached or the end point of the defined interval of rotation angles is reached.

The defined interval of rotation angles is typically between 0° and 90°. In most cases, the seat ring design and the construction of the actuator hinder any motion beyond these angles. But it is also possible that mechanical stoppers prevent the disc or the axis which turns the disc or a part of the actuator which turns the axis, to rotate to values outside this interval. As an alternative, the acceptable interval of rotation angles can be defined by software or wiring of an electronic actuator control unit.

The predefined fixed maximum value of torque can be defined by the maximum torque which can be provided by the actuator. Alternatively, it is again possible to set the predefined fixed maximum value of torque by the software or wiring of an electronic actuator control unit. The predefined fixed maximum value of torque is preferably chosen such that the pressure of the edges of the disc onto the seat is essentially equal to the desired sealing pressure.

The preferred and easiest way to accomplish such an actuator control unit is by using mechanical stoppers and by increasing the torque of the actuator steadily up to the predefined fixed maximum value of torque. This actuator control unit does not need any active measurement systems: The presence or absence of stoppers determines if the disc is still inside the desired interval of rotation angles and the predefined fixed maximum value of torque is reached if either the desired sealing pressure is reached or if the disc has turned so far that the end of the rotation angle interval is reached.

Controlling the maximum torque value instead of the disc position in the first row, allows the use of less powerful actuators, as the sealing pressure is never higher than needed. This saves also energy and reduces wear of the components. Further, a valve with this actuator control unit is self-adapting: With increasing wear of the seat ring, the position in which the sealing pressure between the seat and the valve disc is reached changes. Therefore a control unit which determines the position of the disc needs to be adjusted from time to time. An actuator control unit based on a predefined fixed maximum value of torque, however, will simply observe that the control turns the disc a little bit further until the predefined fixed maximum value of torque and therefore the sealing pressure is reached. Above and in the following, the applied method of such an actuator control unit will be called “constant torque control”, as the predefined fixed maximum value of torque at which the valve is considered to be closed is constant in most cases.

An embodiment comprising an electronic actuator control unit allows more flexibility as the predefined fixed maximum value of torque and the rotation angle interval can be changed electronically. This makes it for example possible to use the same type of actuator on different valves with different desired sealing pressures or to adapt the sealing pressure according to the pressure difference the seal has to withstand without changes on the hardware of the fluid control device.

An actuator control unit is designed to control an actuator of a butterfly valve whereby the butterfly valve comprises a valve disc which is rotatable by the actuator. The actuator control unit, when closing the valve, makes the actuator rotate the valve disc inside a defined interval of rotation angles until either a predefined fixed maximum value of torque is reached or an end point of the defined interval of rotation angles is reached.

As explained above, this actuator control unit can simply consist of mechanical stoppers and an actuator which increases its torque steadily up to a predefined fixed maximum value of torque. An example for a mechanical stopper is a protrusion on the valve axis which collides at the ends of the defined interval of rotation angles with a protrusion on the valve body. Similar protrusions can be on a rotating part of the actuator and the actuator housing. But also the seat ring can be shaped such that the disc cannot rotate further than a maximum value.

The predefined fixed maximum value of torque can be defined by the limits of the actuator. However it is also possible to restrict the torque transferred onto the disc axis. Such a torque limitation is well known from e.g. torque wrenches. It is also possible to control the actuator in such a way that is produces the predefined fixed maximum value of torque by e.g. using a gear or restricting the power supply. Depending on the technique used to restrict the torque, the desired value can be set mechanically (e.g. changing a gear, loading or unloading a spring) or by an electronic actuator control unit (e.g. restricting the power supply or controlling the actuator directly).

It is also possible that the position of the disc and the torque are actively measured and that these measurements are used in an electronic actuator control unit which controls the action of the actuator depending on the measurement results. It is possible to combine the measurement and an electronic actuator control unit based control of the position of the disc with a mechanical control of the torque. It is possible to combine the measurement and an electronic actuator controller unit based control of the torque with a mechanical control of the position of the disc.

In all embodiments of the actuator control unit, if the predefined fixed maximum value of torque can be reached inside the rotation angle interval then the predefined fixed maximum value of torque determines the “closed-position” of the valve. Only if the predefined fixed maximum value of torque cannot be reached, the “closed-position” is one of the limits or end points of the rotation angle interval.

Preferably, the actuator control unit is used to control an actuator of any one of the above described embodiments of a butterfly valve.

Preferably, a method for controlling the closing of a butterfly valve comprising a valve disc which is rotatable by an actuator comprised the following steps: For closing the butterfly valve, the actuator rotates the valve disc until a predefined fixed maximum value of torque is provided by the actuator. If this predefined fixed maximum value of torque is not reached before the valve disc has turned to an end point of a defined interval of rotation angles, the rotation is stopped at this end point.

Preferably this method is used for controlling the closing of a butterfly valve according to any one of the above mentioned embodiments.

The method can be executed by any embodiment of an actuator control unit as specified above. However, it can also be executed if the valve is closed by hand and if there is therefore no traditional actuator involved. The predefined fixed maximum value of torque can be determined by any common measurement system for torques or by limiting the maximum torque which can be transferred to the valve disc. Preferably the predefined fixed maximum value of torque is defined by maximum torque producible by the actuator used. Preferably, the defined interval of rotation angles is defined by the geometry of the seat ring and the disc or by the actuator alone or the actuator and the valve axis or by valve axis and the valve body geometry.

A method for controlling the closing of a butterfly valve comprising a valve disc which is rotatable by an actuator comprises the following steps:
a. Determining if the torque applied by the actuator is smaller than a predefined fixed maximum value of torque
b. If this is the case, determining if the position of the valve disc is smaller than a maximum position
c. If this is the case, increasing the torque and repeating steps a), b) and c).

This is a possible method which can be realized in an embodiment of an actuator control unit and the flow regulating device described above. The maximum position of the disc can be the end point of a defined interval of rotation angles. Preferably, step b) should be interpreted broadly: The indication for the disc having reached the maximum position can, in mechanical systems, be given by the reaching the predefined fixed maximum value of torque. For example mechanical stoppers increase the torque needed for any further motion suddenly by a huge amount and therefore the predefined fixed maximum value of torque is reached. The presence of the predefined fixed maximum value of torque can be detected either in step a) or in step b). In this case, in step b) the high torque is the signal indicating that the maximum position is reached.

The process can also include in step a) the measurement of the value of torque and in step b) the measurement of the position of the disc and comparing them to predefined values, and react with control signals on the actuator in step c).

The process can also include in step a) the measurement of the value of torque and comparing it to the predefined value and in step b) a rotation limitation by mechanical means like e.g. a stopper which causes an increase torque which is determined e.g. by a measurement and comparison as known from step a) or by a torque limiting device. The increase in torque in step c) can happen either because the torque is increased to the predefined fixed maximum value of torque in any case or because a control signal is created which causes the actuator to increase the torque.

The process can also include in step a) the use of a torque limiting device as described above and in step b) the measurement of the position of the disc and comparison of it to the predefined value. The increase in torque in step c) can happen either because the torque is increased to the predefined fixed maximum value of torque in any case or because a control signal is created which causes the actuator to increase the torque. The control signal is preferably based on a detected movement of the disc in this case as a non-moving disc is an indication that the predefined fixed maximum value of torque is reached. Thereby, standstill detection of the disc can be used to detect that the predefined All embodiments of the actuator control unit and the process described above can be used with any one of the embodiments of butterfly valves as described above. Other advantageous embodiments and combinations of features come out from the detailed description below and the totality of the claims.

### BRIEF DESCRIPTION OF THE DRAWINGS

The drawings used to explain the embodiments show:

FIG. 1a-d Cross-sections of a seat ring.

FIG. 2 A cross-section of a valve disc.

FIG. 3 A cross-section of a seat ring, a valve disc and a valve axis in the mounted arrangement.

FIG. 4 A butterfly valve with an adapter and a position indicator in the open position.

FIG. 5 A butterfly valve with adapter, position indicator and actuator in the closed position.

FIG. 5b An actuator receiving element of an adapter.

FIG. 6 Voltage detection and correction means.

FIG. 7 A hand crank detector for a butterfly valve.

FIG. 8 Safety subsystem of an actuator for a butterfly valve.

FIG. 9 The complete butterfly valve assembly.

FIG. 10 Flow chart of the control algorithm for closing the valve.

In the figures, the same components are given the same reference symbols.

### PREFERRED EMBODIMENTS

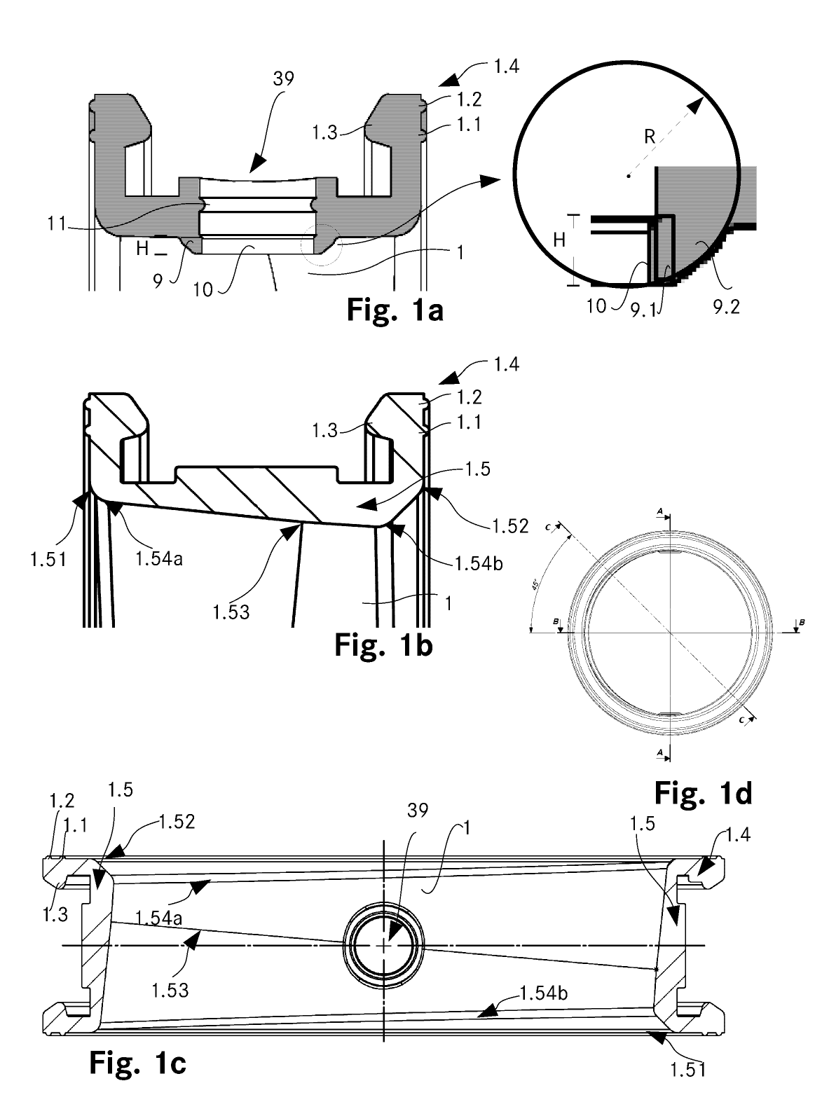

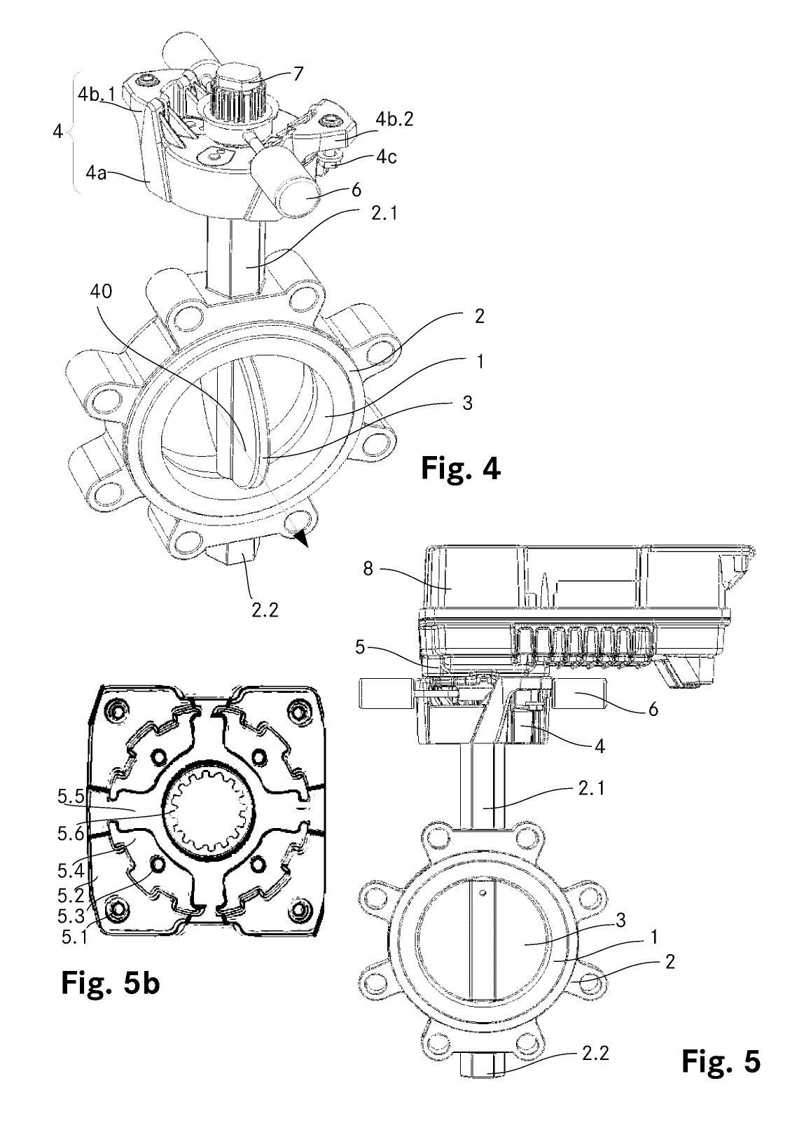

FIG. 1a shows a cross-section of a seat ring 1 for a butterfly valve. The plane of the cross-section passes through the middle of one of the two holes 39 for the valve axis 16. The flow direction 40 (FIG. 4) of the fluid and the rotation axis 14 of the valve disc 3 also lie in the plane of the cross-section. The orientation of the cross-sectional plane is indicated in FIG. 1d, which shows the seat ring 1. The orientation of the cross-sectional plane shown in FIG. 1a is labelled A.

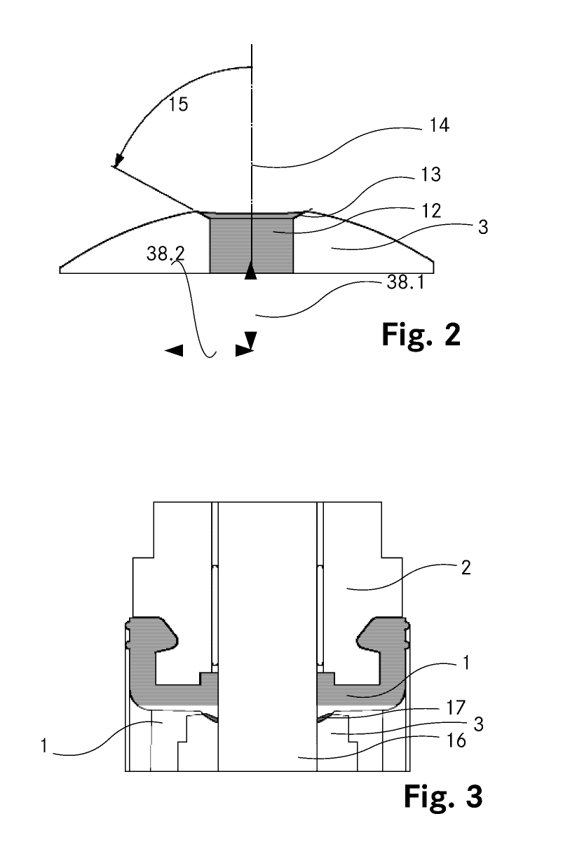

The seat ring 1 shows three protrusions: One of them, the protrusion 9, extends into the main volume of the valve while a second protrusion 10 extends in radial direction 38.2 (FIG. 2) in the hole 39 for the valve axis. A third protrusion 11 extends also in radial direction 38.2 (FIG. 2) in the hole 39 for the valve axis.

Apart from the protrusion 9 and outside of the hole 39 for the valve axis, the surface of the seat ring 1 has in this cross-section approximately a U-shape which is wider than high. On the highest ends 1.4 of the U, there are fixing protrusions 1.1, 1.2 and 1.3, one to the inside (1.3) and two to the outside (1.1 and 1.2) of the U-shape. The fixing protrusions 1.1, 1.2, 1.3 are used to fix the seat ring 1 to the valve body 2.

When the cross-sectional plane is rotated around the flow direction of the liquid 40 (FIG. 4) the shape of the seat ring 1 in these new cross-sections changes. This is shown in FIGS. 1b and 1c. The orientations of the cross-sectional plane is shown in FIG. 1d and it is labelled B. Outside the holes 39 for the valve axis and the surrounding protrusion 9, the shape of the lower part of the U becomes more pentagon-like 1.5. The corner points 1.51 and 1.52 of this pentagon are the two points on the baseline of the U (base points). The third point 1.53, the forth point 1.54a and the fifth point 1.54b are placed further inside the main volume of the valve. The distance between one of the base points 1.51 or 1.52 and the third point 1.53 changes. The location of the third point is shown in FIG. 1a, b by a slightly curved line approximately in the middle of the seat ring 1.

FIG. 1c shows the complete cross-section B as indicated in FIG. 1d. In this view, it becomes clear how the position of the third 1.53, forth 1.54a and fifth 1.54b corner point of the pentagon changes along the seat ring 1.

FIG. 1b shows a detail of FIG. 1c and therefore the description of FIG. 1b applies for FIG. 1c, too. FIG. 1c shows further the hole 39 for the valve axis: it is the round hole in the center. The distance between the two corner points 1.51 and 1.52 is constant along the seat ring. With increasing distance from the center, the third point 1.53 of the pentagon-like shape comes closer to one of the corner points 1.51 or 1.52 and therefore away from the other corner point 1.52 or 1.51.

In FIG. 1a, the hub-area can be seen in detail: The protrusion 9 extends a certain height H into the inner part of the valve. In the cross-section, it has a shape which is a combination of a circle segment 9.2 and maybe also a rectangle 9.1. If one rotates the cross-section around the rotation axis 14 of the valve axis, this shape is in every one of these cross-sections very similar. Differences exist only in the region where the protrusion 9 goes over to the seat ring 1 outside the protrusion 9. The circle segment can have a radius R different from the height H, preferably a radius R is larger than the height H. The protrusion 9 is a contacting surface.

The second protrusion 10 extends towards the valve axis 16 at the position of the protrusion 9. Here the second protrusion 10 is shown to be approximately rectangular in the cross-section. The second protrusion 10 surrounds the valve axis 16.

The third protrusion 11 is O-ring like. It has an essentially semi-circular shape in the cross-section. The third protrusion 11 is located on the surface of the seat ring 1, oriented towards the valve axis 16. It is further away from the main volume of the valve than the second protrusion 10.

FIG. 2 shows a valve disc 3 which can form a seal together with the seat ring 1 shown in FIG. 1. In the cross-section shown, the valve disc 3 has an essentially circular shape. FIG. 2 shows only the upper part of the valve disc 3. Along the rotation axis 14 of the butterfly valve, there is an opening 12 for the valve axis. This opening 12 is essentially of cylindrical shape, however, it is not everywhere a circular cylinder but at least in part a not-circular cylinder. In the exit region of the opening for the valve axis 12, there is a cone-shaped indentation 13. The cone-shaped indentation 13 is not a complete cone, but only part of the surface of a cone. This cone has a half opening angle 15 and is centered along the rotation axis of the valve 14. The cone-shaped indentation 13 is a contacting surface.

FIG. 3 shows the seat ring 1, the valve disc 3, the valve body 2 and the valve axis 16 in the mounted state. Note that the seat ring 1 shown in FIG. 3 is not exactly the same embodiment as the one shown in FIG. 1. The seat ring 1 in FIG. 3 does not have a second and a third protrusion 10, 11. Instead, the opening for the valve axis is designed such that it forms a seal together with the valve axis 16. There is a region close to the valve axis 16 where the protrusion 9 of the seat ring 1 and the cone-shaped indentation 13 of the valve disc 3 overlap. In reality, this overlap is not possible but results in a high pressure between seat ring 1 and valve disc 3 and a deformation of the seat ring 1. This high pressure contact secures the function of a seal.

FIG. 4 shows the assembled butterfly valve without actuator. The valve body 2 has essentially the shape of a short tube. There are connecting elements for the connection with pipes on the input and output of the valve. There are further cylinders extending from the top 2.1 and the bottom 2.2 of the valve body 2 which can receive at least parts of the valve axis 16. The seat ring 1 is located inside the valve body 2. Inside the seat ring 1 there is the valve disc 3. The valve disc 3 is kept in its position by the valve axis 16. The valve axis 16 extends through the cylinder 2.1 extending to the top. On this cylinder 2.1, an axis receiving element 4 of an adapter, consisting of the axis receiving element 4 and the actuator receiving element 5, is mounted. Preferably, there is a standard ISO flange on the cylinder 2.1 onto which the axis receiving element 4 can be mounted, e.g. with screws. This axis receiving element 4 has two parts: There is a bottom part 4a which is of circular shape and which is mounted to the cylinder 2.1 extending to the top. And there is a top part 4b comprising two axis-receiving-element-protruding sections 4b.1 and 4b.2 which hold screws 4c. The valve axis 16 passes through the adapter and is covered by a coupling device 7. Onto this coupling device 7, a position indicator 6 may be mounted.

The position indicator 6 has in its center a ring-like part which is on its inside formed complementary to the outside of the coupling device 7. From this ring-like part two sticks extend in directions opposite to each other. The sticks themselves are well visible and/or reflective. At the end of the sticks, well visible and/or reflective end pieces are connected. Preferably, the sticks are flexible and the end pieces are soft and flexible. A collision with the position indicator will make no harm.

The position indicator 6 is mounted on the coupling device 7 by pushing the ring-like part onto the coupling device 7. Due to the form-fit connection between the valve axis 16 and the coupling device 7 and the position indicator 6, the rotation of the valve axis 16 causes the rotation of the coupling device 7 which causes the rotation of the position indicator 6. Preferably, the position indicator 6 is mounted such that the sticks extend in the plane defined by the plane of the valve disc 3. Thereby, the sticks and the end pieces of the sticks indicate the position of the valve disc 3. The axis-receiving-element-protruding sections 4b.1 and 4b.2 occupy each one less or equal to 90° of the circle surrounding the rotation axis of the valve. This allows the position indicator 6 to move to all positions which occur during nominal operations of a butterfly valve.

FIG. 5 shows the same butterfly valve as FIG. 4 including the same valve body 2, the same seat ring 1 and valve disc 3. There is also the adapter shown. The adapter comprises the axis receiving element 4 and the actuator receiving element 5. The axis receiving element 4 is connected to an actuator receiving element 5. This connection is preferably a form fit connection secured and stabilized by a connection with screws 6. The actuator receiving element 5 is connected to the actuator 8 by being a part of the actuator housing. Preferably, there are only two screws 6 needed to stabilize the connection between the actuator receiving element 5 and the axis receiving element 4.

FIG. 5b shows the actuator receiving element 5, which is in this case a part of the actuator housing. Alternatively, the actuator receiving element 5 can be fixed to the actuator housing by suitable means as e.g. screws, adhesives, clip connections, bands and similar connections. In this view, the actuator receiving element is mirror symmetric about two perpendicular axis. We describe therefore only one quarter of it, although all four quarters are shown. In the center of this view of the actuator receiving element 5, there is the connection element to the coupling device 5.6. It is an indentation which a complementary shape to the coupling device 7 so that a form-fit connection between the connection element 5.6 and the coupling device 7 can be established by simply pushing the coupling device 7 into the connection element 5.6. The connection element is surrounded by a region which is lower than the other parts shown in this figure except for the connection element 5.6. This lower region is called indentation section 5.5. On the indentation section, there are actuator-receiving-element-base sections 5.2. They are located above the indentation section 5.5 and have an approximately triangle shape. The shape of the actuator-receiving-element-base sections 5.2 surface is approximately the same as the shape of the Axis-receiving-element-protruding sections 4b.1 or 4b.2. There is a screw receiving thread 5.1 on each one of the actuator-receiving-element-base sections 5.2 which can receive the screws 6 in order to fix the actuator receiving element 5 to the axis receiving element 4. In order to establish the form fit, the actuator receiving element 5 comprises further protrusions 5.4 which protrude between the actuator-receiving-element-base sections 5.2 and the Indentation section 5.5 which surrounds the connection element 5.6. The protrusions 5.4 are formed such that they can establish a form-fit connection with the axis-receiving-element-protruding sections 4b.1 and 4b.2. There are standard threads 5.3 in the protrusions 5.4 which can receive the screws which are used in a standard ISO connection between a valve flange and an actuator 8. Therefore, an actuator 8 with a housing that comprises an actuator-receiving-element 5 can be connected to a valve with a standard ISO flange or with an axis-receiving element 4.

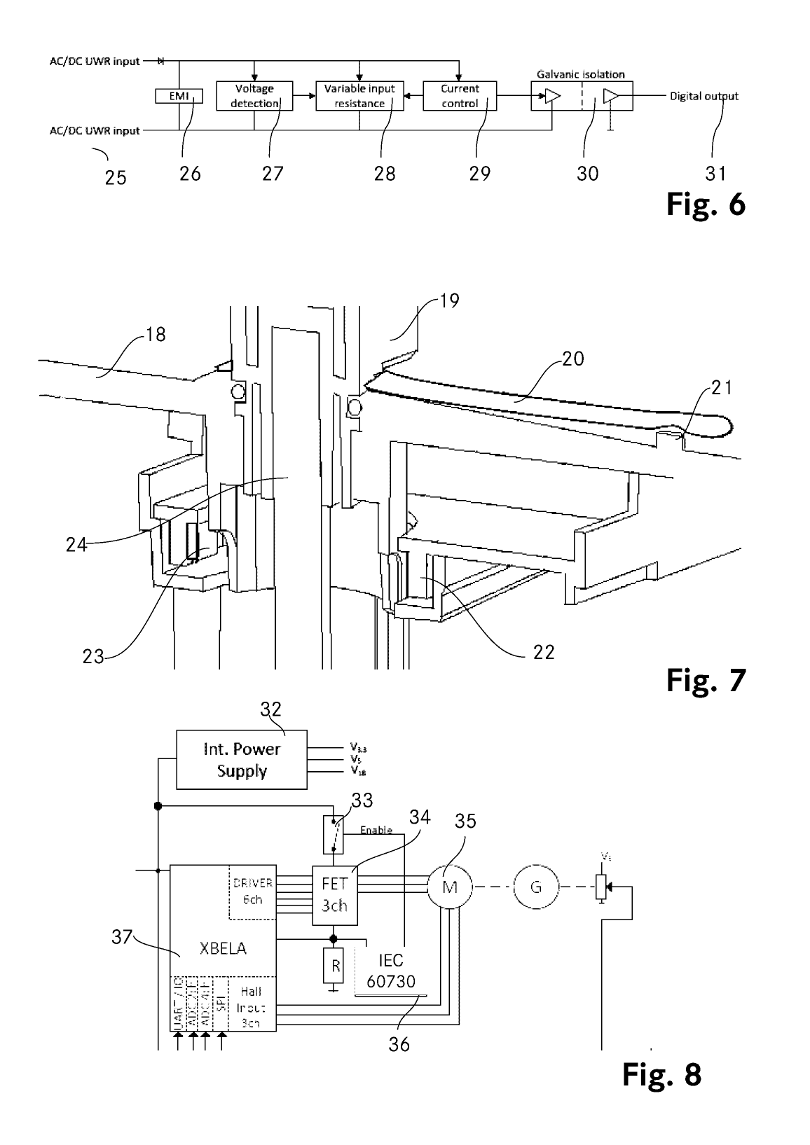

FIG. 6 shows a diagram of the voltage detection means for control signals. On the left side there is the input 25 for control signals carries by AC or DC voltages between 19 and 265 V (effective voltage). The first box represents an electromagnetic interference filter unit (EMI) 26. The second box represents the voltage detection unit 27. The detected value from the voltage detection unit 27 enters the control of a variable input resistance 28. A forth box represents a current control unit 29. The current control unit 29 comprises two outputs: One goes to the control of the variable input resistance 28 and the other to a galvanically isolated unit 30. The galvanically isolated unit 30 converts the input signal into a digital output 31 of predefined voltage, current and waveform.

The EMI 26, the voltage detection unit 27, the variable input resistance 28 and the combination of current control 29 and galvanically isolated unit 30 are connected in parallel. The current control 29 and galvanically isolated unit 30 are connected in series.

FIG. 7 shows a hand crank detector for a butter fly valve. The hand crank, shown here with the parts 19, 20 and 24, can be inserted into the housing of the actuator 18. The hand crank itself comprises a housing 19, a position indicator 20 and an axis 24. The axis 24 is inserted into the housing of the actuator 18 and blocks thereby the light path between an IR-sender 23 and an IR-receiver 22. This blockage is detected by a suitable electronic board located inside the actuator housing 18 and this electronic board gives a signal to the actuator 8 not to block the valve against the motions caused by the hand crank.

In the mounted state, the hand crank housing 19 and the housing of the actuator 18 are connected with seals in between them. Thereby, no fluid or dirt from inside the actuator housing 18 can pass through the opening and, more important, nothing from the outside like e.g. dirt or water can enter the actuator housing 19.

The position indicator of the hand crank 20 allows the user to see immediately the position of the valve. A stopper 21, being formed or being connected to the actuator housing 18, prevents the user from applying unnecessary and potentially harmful pressure to an already closed valve.

FIG. 8 shows a safety subsystem. The safety subsystem is powered by the internal power supply 32 of the actuator. The power supply 32 transfers the power to the actuator 35 via a switch 33 and three field effect transistors (FET) 34. The FETs 34 are controlled by programmable controller 37. The programmable controller 37 receives measurements of three hall sensors which measure actuator parameters. The programmable controller 37 can connect the actuator 35 to the power supply 32 by commanding the control unit IEC 60730 36 to close the switch 33. The programmable controller 37 itself is directly connected to the power supply 32. Therefore, it can work independent of the power supplied to the actuator 35.

The number of hall sensors and FETs can be different from three, but preferably it is greater than zero.

In the case of failure of the safety subsystem, the switch 33 falls in its default position and disconnects the actuator 35 from the power supply 32. Preferably, the default position of the switch 33 is its open-position. In the case of strange or undesired actuator 35 behavior, the hall sensors detects this and the programmable controller 37 can either adapt the power given to the actuator 35 by controlling the FETs 34 differently or it can disconnect the actuator 35 from the power supply 32 completely by allowing the switch 33 to return to its default position. The software loaded onto the programmable controller 37 can be updated and parameters needed by the programmable controller can be updated, too. The software determines the reaction of the programmable controller on measurements and inputs.

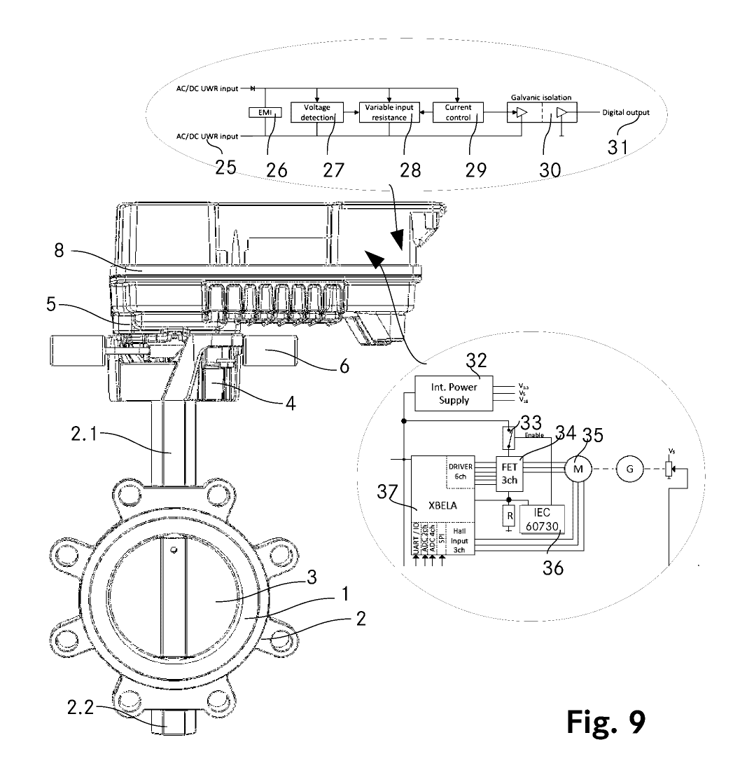

FIG. 9, shows the complete setup comprising the valve body 2, the seat ring 1, the valve disc 3, the valve axis 16 (not visible as it is placed inside the valve disc 3 and the cylindrical extensions 2.1 and 2.2 of the valve body). There is further the adapter shown which comprises the axis receiving element 4 and the actuator receiving element 5, the position indicator 6 and the actuator 8. The actuator includes the voltage detection unit comprising the parts 25 to 31 and the safety subsystem including the parts 32 to 37.

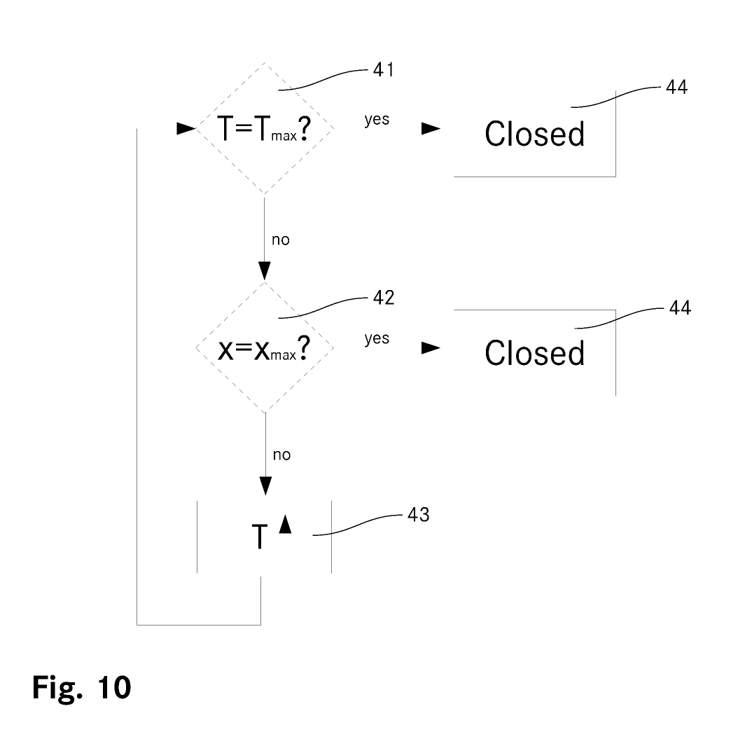

FIG. 10 is a flow chart of the algorithm used to close the valve. The first step is a torque measurement 41. In the torque measurement step 41, the measured torque is compared to a reference value Tₘₐₓ, in order to find out if the torque is equal to the reference value Tₘₐₓ (T=Tₘₐₓ) or below it (T<Tₘₐₓ). Preferably, Tₘₐₓ which is the reference value, is the predefined fixed maximum value of torque. Preferably Tₘₐₓ is the maximum value of torque producible by the actuator and therefore T cannot be larger than Tₘₐₓ. Therefore it is also possible, that the torque measurement step 41 determines T≠Tₘₐₓ. However if the actuator can produce more torque, then the comparison should either decide if the torque is “larger or equal to Tₘₐₓ” (T≧Tₘₐₓ) or three options should be tested: T<Tₘₐₓ; T=Tₘₐₓ and T>Tₘₐₓ.

In the case of the output being T=Tₘₐₓ or T≧Tₘₐₓ, the valve is considered to be in the close state 44.

In the case of the output being T>Tₘₐₓ, there are two possibilities: either the valve is considered to be in the close state 44, too, or the torque is reduced until T=Tₘₐₓ. Reducing the torque to the reference value safes energy and minimized material wear and is therefore preferred. However it requires more complicated control logic.

In the case of T<Tₘₐₓ or T≠Tₘₐₓ, a position measurement step 42 is entered. Here the position of the valve disc x is compared to a reference value xₘₐₓ. x should always be smaller or equal to xₘₐₓ. This can be ensured by the design of the seat ring and the disc. Therefore in one embodiment, possible outcomes of the position measurement step 42 are x=xₘₐₓ or x<xₘₐₓ. In a second embodiment, the possible outcome are x=xₘₐₓ or x≠xₘₐₓ. In a third embodiment, it is however also possible that the position measurement step 24 includes the determination of the states “x>xₘₐₓ”, “x<xₘₐₓ” and “x=xₘₐₓ”.

The states x<xₘₐₓ and x≠xₘₐₓ show that the final position is not yet reached and a torque increasing step 43 is entered.

In the state x=xₘₐₓ, the valve is considered to be in the close state 44.

In the state x<xₘₐₓ, the valve is probably broken as the disc has turned more than 90°. Preferably, an error message is released and the actuator is turned off. There may be valve designs in which it is not a problem if the valve disc has turned that much, and where the actuator can be used to bring the disc in a desired position. A suitable control algorithm can be started at this point.

The torque increasing step 43 commands the actuator to increase the torque by a small amount and the algorithm enters the torque measurement step 41 again.

All comparisons can include tolerances. For example, the state “T=Tₘₐₓ” can be reached for measured torques between Tₘₐₓ−Δ₁ and Tₘₐₓ+Δ₂, whereby Δ₁ and Δ₂ can have the same or different values which are preferably small compared to Tₘₐₓ. Preferably Δ₁ and Δ₂ are both less than 10% of Tₘₐₓ, preferably Δ₁ and Δ₂ are both less than 1% of Tₘₐₓ, preferably, similar considerations are true for the states T≧Tₘₐₓ, T>Tₘₐₓ, T<Tₘₐₓ, x>xₘₐₓ, x<xₘₐₓ, x=xₘₐₓ and x≠xₘₐₓ. In summary, it is to be noted that the protrusion 9, the second protrusion 10 and the third protrusion 11 can have different shapes. For example the protrusion 9 and the second protrusion 10 may have a combined cross-section in the shape of a circle segment. The second protrusion 10 could have a similar cross-section as shown for the third protrusion 11 in FIG. 1. It is also possible that the protrusion 9 does not have a rounded part of the surface but that its cross-section has a triangular shape. Also the shape of the seat ring 1 outside these three protrusions can have a different shape.

Also the cone-shaped contacting surface 13 of the valve disc 3 does not need to be cone-shaped. For example, its cross-section may comprise a convex rounded part and/or circle segments. A rounded part is preferable if the protrusion 9 is not rounded in its cross-section.

The bottom part 4a of the axis receiving element 4 of the adapter does not need to have a circular cylindrical shape but it can also be a rectangular box. Its lower surface does not need to be parallel to its upper surface. The lower surface can for example, extend further downwards, surrounding the valve axis.

The valve body 2 can have a different shape. For example it can be longer or its upper and lower part can extend further along the valve axis. It is also possible that the connection elements to the pipes are designed differently.

The coupling device 7 can have a number of different shapes as long as it is not round. It can have for example a triangular cross-section, the shape of a cross or a blade or a polygon. It is also possible to use no coupling device 7 at all, but to connect the valve axis directly to the actuator 8 and possibly to the position indicator 6.

The actuator 8 can be mounted immediately to the valve axis 16 without any axis receiving element 4 or actuator receiving element 5.

The axis receiving element 4 and the actuator receiving element 5 can be connected by means other than form-fit connections and screws. For example bolts or click systems can be used or clamping straps as well as many other well-known connection systems.

The hand crank does not need to comprise a position indicator 20 and a stopper 21 or the position indicator 20 and stopper 21 can be designed in a different way. For example, a position indicator 20 can be a simple reference line drawn on the hand crank and/or on the housing which translates a hand crank position into a valve disc position.

1. A butterfly valve comprising a seat ring, a centered valve disc and a valve axis, wherein
a) the seat ring and the valve disc are constructed to co-operate as first and second elements of a seal for sealing a volume in which the valve axis is located from internal volume of the valve,
b) the seal is substantially a radial-force-type seal with respect to the valve axis, characterized in that
c) the torque for opening or closing the valve is not more than 160 Nm.

2. A butterfly valve comprising a seat ring, a centered valve disc and a valve axis, wherein
a) the seat ring and the valve disc are constructed to co-operate as first and second elements of a seal for sealing a volume in which the valve axis is located from an internal volume of the valve,
b) the seal is substantially a radial-force-type seal with respect to the valve axis, characterized in that
c) the elements are constructed to limit a sealing pressure to a slim line.

3. A butterfly valve according to claim 1, characterized in that
a) a first contacting surface associated with the first element is convex-shaped and rounded in a radial cross-section with respect to the valve axis and
b) a second contacting surface associated with the second element is cone-shaped in a radial cross-section with respect to the valve axis.

4. A butterfly valve according to claim 2, characterized in that
a) a first contacting surface associated with the first element is convex-shaped and rounded in a radial cross-section with respect to the valve axis and
b) a second contacting surface associated with the second element is cone-shaped in a radial cross-section with respect to the valve axis.

5. A butterfly valve according to claim 1, characterized in that
a) the contacting surfaces of both elements are rounded in a radial cross-section with respect to the valve axis.

6. A butterfly valve according to claim 2, characterized in that
a) the contacting surfaces of both elements are rounded in a radial cross-section with respect to the valve axis.

7. A butterfly valve according to claim 3, characterized in that of the first and/or the second contacting surface is rounded in a radial cross-section with respect to the valve axis and encircles the valve axis completely at a predetermined axial position with respect to the valve axis.

8. A butterfly valve according to claim 5, characterized in that of the first and/or the second contacting surface is rounded in a radial cross-section with respect to the valve axis and encircles the valve axis completely at a predetermined axial position with respect to the valve axis.

9. A butterfly valve according to claim 4, characterized in that of the first and/or the second contacting surface is rounded in a radial cross-section with respect to the valve axis and encircles the valve axis completely at a predetermined axial position with respect to the valve axis.

10. A butterfly valve according to claim 6, characterized in that of the first and/or the second contacting surface is rounded in a radial cross-section with respect to the valve axis and encircles the valve axis completely at a predetermined axial position with respect to the valve axis.

11. A butterfly valve according to claim 3, characterized in that a cone-shaped contacting surface is formed such that the contacting surface comes closer to the co-operating element with increasing radial distance with respect to the valve axis.

12. A butterfly valve according to claim 4, characterized in that a cone-shaped contacting surface is formed such that the contacting surface comes closer to the co-operating element with increasing radial distance with respect to the valve axis.

13. A butterfly valve according to claim 3, characterized in that the cone-shaped contacting surface is associated with the valve disc and the convex-shaped and rounded contacting surface is associated with the seat ring.

14. A butterfly valve according to claim 4, characterized in that the cone-shaped contacting surface is associated with the valve disc and the convex-shaped and rounded contacting surface is associated with the seat ring.

15. A butterfly valve according to claim 3, characterized in that the rounded contacting surface of at least one element is part of a protrusion of said element towards the co-operating element, preferably the protrusion is a protrusion of the seat ring which protrudes towards the valve disc.

16. A butterfly valve according to claim 5, characterized in that the rounded contacting surface of at least one element is part of a protrusion of said element towards the co-operating element, preferably the protrusion is a protrusion of the seat ring which protrudes towards the valve disc.

17. A butterfly valve according to claim 4, characterized in that the rounded contacting surface of at least one element is part of a protrusion of said element towards the co-operating element, preferably the protrusion is a protrusion of the seat ring which protrudes towards the valve disc.

18. A butterfly valve according to claim 6, characterized in that the rounded contacting surface of at least one element is part of a protrusion of said element towards the co-operating element, preferably the protrusion is a protrusion of the seat ring which protrudes towards the valve disc.

19. A butterfly valve according to claim 16, characterized in that the protrusion including the rounded surface is the region closest to the valve disk.

20. A butterfly valve according to claim 18, characterized in that the protrusion including the rounded surface is the region closest to the valve disk.

21. A butterfly valve according to claim 16, characterized in that in at least one radial cross-section with respect to the valve axis, the distance between the seat ring and the valve disc does not decrease along a line starting from the point with the smallest distance between seat ring and valve disc on the protrusion and moving away from the valve axis in radial direction.

22. A butterfly valve according to claim 18, characterized in that in at least one radial cross-section with respect to the valve axis, the distance between the seat ring and the valve disc does not decrease along a line starting from the point with the smallest distance between seat ring and valve disc on the protrusion and moving away from the valve axis in radial direction.

23. A butterfly valve according to claim 16, characterized in that there is a second protrusion protruding in radial direction towards the valve axis, which stabilizes the position of the protrusion and which seals a first volume between the valve disc and the valve axis from a second volume between a valve body and the valve axis.

24. A butterfly valve according to claim 18, characterized in that there is a second protrusion protruding in radial direction towards the valve axis, which stabilizes the position of the protrusion and which seals a first volume between the valve disc and the valve axis from a second volume between a valve body and the valve axis.

25. A butterfly valve according to claim 23, characterized in that there is a third protrusion, protruding in radial direction towards the valve axis and which is further away from the valve disc than the second protrusion and which seals a second volume between the valve body and the valve axis from a third volume between the valve axis and an outside or a valve actuator.

26. A butterfly valve according to claim 24, characterized in that there is a third protrusion, protruding in radial direction towards the valve axis and which is further away from the valve disc than the second protrusion and which seals a second volume between the valve body and the valve axis from a third volume between the valve axis and an outside or a valve actuator.

27. A butterfly valve according to claim 25, characterized in that the third protrusion is at least partially shaped like an O-ring.

28. A butterfly valve according to claim 26, characterized in that the third protrusion is at least partially shaped like an O-ring.

29. A butterfly valve according to claim 1, characterized in that the seat ring is composed of elastomer and the valve disk is composed of a less flexible material than the seat ring, preferably of steel.

30. A butterfly valve according to claim 2, characterized in that the seat ring is composed of elastomer and the valve disk is composed of a less flexible material than the seat ring, preferably of steel.

31. Adapter for the connection of a butterfly valve axis to an actuator which comprises an actuator receiving element and an axis receiving element whereby
a) The actuator receiving element is mounted to or is a part of an actuator and
b) The axis receiving element is mounted to or is a part of a valve body and
c) The actuator receiving element and the axis receiving element can be detachably connected to each other, preferable by having form-fitting shapes and screws to fix a position relative to each other and
d) The axis receiving element comprises
a. a bottom and a top part
b. Whereby the bottom part surrounds the valve axis and
c. Whereby the top part comprises four sections, each of approximately 90°, whereby two sections, being on opposite sides of the valve axis, comprise axis-receiving-element-protrusions and the other two sections are empty.
e) The actuator receiving element comprises preferably
d. Two base sections which can receive the axis-receiving-element-protrusions of the axis receiving part at least partially.

32. Actuator for a butterfly valve, characterized in that it comprises voltage detection means which are coupled to a variable input resistance such that the voltage available to the circuit connected in parallel to the resistance has a given value independent of the input voltage, preferable for input voltages between 19 V and 265 V AC or DC.

33. Actuator for a butterfly valve, characterized in that it comprises a temperature and/or humidity controller which comprises
a) One or more sensors for temperature and/or humidity and
b) One or more heaters
c) Whereby the heaters are controlled depending on the sensor measurements in order to avoid condensation of humidity in or on the actuator and/or in order to prevent frost in or on the actuator or movable parts close to it.

34. Actuator for a butterfly valve, characterized in that it comprises a safety subsystem which protects the actuator from risk of fire in fault conditions and which comprises electronic hardware and software running on and controlling the electronic hardware, whereby the software comprises three parts: a bootstrapper, a boot-loader allowing software updates in boot mode and the actual safety firmware.

35. Hand crank detector for a butterfly valve, characterized in that there is an IR light barrier inside a socket for a hand crank which gives out a signal which prevents the operation of an actuator for a butterfly valve if the IR barrier is disturbed.

36. Indicator for the position of a butterfly valve disc, characterized in that it comprises a flexible stick which can be coupled to a valve axis of the butterfly valve and which is oriented in the same way as the valve disk in every position the valve disc can be in.

37. A flow regulating device comprising
a) a butterfly valve comprising a valve disc which is rotatable, and
b) an actuator, and
c) an actuator control unit designed to control the actuator for bringing the butterfly valve into a closed state, whereby, when closing the valve, the actuator rotates the valve disc inside a defined interval of rotation angles until either a predefined fixed maximum value of torque is reached or the end point of the defined interval of rotation angles is reached.

38. A flow regulating device according to claim 37, wherein the butterfly valve comprises a seat ring, a centered valve disc and a valve axis, wherein
a) the seat ring and the valve disc are constructed to co-operate as first and second elements of a seal for sealing a volume in which the valve axis is located from internal volume of the valve,
b) the seal is substantially a radial-force-type seal with respect to the valve axis, characterized in that
c) the torque for opening or closing the valve is not more than 160 Nm.

39. An actuator control unit designed to control an actuator of a butterfly valve
a) whereby the actuator is capable of rotating a valve disc of the butterfly valve
b) and whereby the actuator control unit, when closing the valve, makes the actuator rotate the valve disc inside a defined interval of rotation angles until either a predefined fixed maximum value of torque is reached or an end point of the defined interval of rotation angles is reached.

40. An actuator control unit according to claim 39 whereby the butterfly valve comprises a seat ring, a centered valve disc and a valve axis, wherein
a) the seat ring and the valve disc are constructed to co-operate as first and second elements of a seal for sealing a volume in which the valve axis is located from internal volume of the valve,
b) the seal is substantially a radial-force-type seal with respect to the valve axis, characterized in that
c) the torque for opening or closing the valve is not more than 160 Nm.

41. An actuator control unit according to claim 39 whereby the butterfly valve comprises a seat ring, a centered valve disc and a valve axis, wherein
a) the seat ring and the valve disc are constructed to co-operate as first and second elements of a seal for sealing a volume in which the valve axis is located from an internal volume of the valve,
b) the seal is substantially a radial-force-type seal with respect to the valve axis, characterized in that
c) the elements are constructed to limit a sealing pressure to a slim line.

42. Method for controlling the closing of a butterfly valve comprising a valve disc which is rotatable by an actuator, whereby, for closing the butterfly valve, the actuator rotates the valve disc until a predefined fixed maximum value of torque is reached and if this predefined fixed maximum value of torque is not reached before the valve disc has turned to an end point of a defined interval of rotation angles, the rotation is stopped at this end point.

43. Method for controlling the closing of a butterfly valve according to claim 42, comprising the steps of:
a) Determining if the torque applied by the actuator is smaller than a predefined fixed maximum value of torque
b) If this is the case, determining if the position of the valve disc is smaller than a maximum position
c) If this is the case, increasing the torque and repeating steps a), b) and c).

44. A method according to claim 42 for closing a butterfly valve comprises a seat ring, a centered valve disc and a valve axis, wherein
a) the seat ring and the valve disc are constructed to co-operate as first and second elements of a seal for sealing a volume in which the valve axis is located from internal volume of the valve,
b) the seal is substantially a radial-force-type seal with respect to the valve axis, characterized in that
c) the torque for opening or closing the valve is not more than 160 Nm.

45. A method according to claim 42 for closing a butterfly valve comprises a seat ring, a centered valve disc and a valve axis, wherein
a) the seat ring and the valve disc are constructed to co-operate as first and second elements of a seal for sealing a volume in which the valve axis is located from an internal volume of the valve,
b) the seal is substantially a radial-force-type seal with respect to the valve axis, characterized in that
c) the elements are constructed to limit a sealing pressure to a slim line.
